(19) United States
(12) Patent Application Publication
(10) Pub. No.: US 2012/0212678 A1
(43) Pub. Date: Aug. 23, 2012

(54) MULTIMEDIA TELEVISION REMOTE CONTROL HAVING A CURSOR CONTROL FUNCTION

(76) Inventor: Chien-Fa WANG, New Taipei City (TW)

(21) Appl. No.: 13/031,797

(22) Filed: Feb. 22, 2011

(51) Int. Cl. H04N 5/44

(52) U.S. Cl. 348/734; 348/E05.096

(57) ABSTRACT

A multimedia television remote control having a cursor control function has a button assembly, a microprocessor, a pointing device, a transceiver, a display and a power supply. The pointing device has a trackball or a joystick and an axial coding unit, outputs a set of coordinate signals after sensing a movement of the trackball or joystick operated by users, and output the set of coordinate signals so as to control a television to generate a cursor on the TV screen for operation. Accordingly, the multimedia television remote control addresses a more convenient operation and increases users' willingness to operate the remote control.

### BACKGROUND OF THE INVENTION

1. Field of the Invention

The present invention relates to a multimedia television remote control, and more particularly to a multimedia television remote control having a cursor control function to facilitate remotely controlling a cursor on a television screen.

2. Description of the Related Art

In response to rapid and booming development of communication industry, more and more 3C home appliances are featured with wireline and wireless communication capabilities. Multimedia related industry also has substantial achievement in building a platform to converge video, data and voice information. For example, the media company, GOOGLE™, recently announced a triple-play system in support of convergence of television, telephony and interne access. Consumers can directly place an order through a television to purchase merchandise on an inviting TV commercial through the triple-play system when watching a TV program and the TV commercial at the same time.

An interne protocol interactive advertisement device has a digital set top box connected to a server and accessing TV programs or advertisements stored in a web service server through the HTTP protocol based on user's preference. Users can interact with TV programs and TV commercials, and directly place an order to purchase merchandise promoted on a TV commercial. When users intend to purchase the merchandise broadcasted on a TV commercial, a multimedia TV remote control can be incorporated for the purchasing operation. Current multimedia TV remote controls in the market pertain to a key-operated type. When a TV shows a column type choice in a TV commercial and users intend to pick the choice, users must keep pressing the up, down, left and right arrow keys of a TV remote control to move a highlighted area to the choice and then input corresponding commands. Many button strokes may be needed in selecting a single column choice with the TV remote control. To complete a transaction on a TV screen, multiple column choices may need to be selected for inputting various purchasing commands. Using a multimedia TV remote control to perform TV shopping is not only inconvenient but also time wasting, and indirectly lowers users' purchase intention for TV shopping. Thus, the conventional multimedia TV remote controls need to be further improved.

### SUMMARY OF THE INVENTION

An objective of the present invention is to provide a multimedia television remote control having a cursor control function to facilitate remotely controlling a cursor on a television screen.

To achieve the foregoing objective, the multimedia television remote control having a cursor control function has a button assembly, a microprocessor, a pointing device, a transceiving module, a display and a power supply.

The button assembly has a television button set.

The microprocessor serves as a computation control center, stores television control code data and television control signals, and reads and outputs one of the television control code signals in accordance with corresponding television control code data when receiving a button press signal from the television button set.

The pointing device has a trackball and an axial coding unit. The axial coding unit senses a rolling movement of the trackball and converts the rolling movement into a corresponding set of coordinate signals.

The transceiving module is connected to the microprocessor and the pointing device, receives the television control signal and the set of coordinate signals, converts the television control signal and the set of coordinate signals into radio signals, wirelessly transmits the radio signals out, is adapted to receive multimedia signals transmitted from an external network, and converts and transmits the multimedia signals to be processed into multimedia data by the microprocessor to the microprocessor.

The display is connected to the microprocessor for displaying the multimedia data processed and outputted by the microprocessor.

The power supply supplies an operating power to the button assembly, the microprocessor, the pointing device, the transceiving module and the display.

To achieve the foregoing objective, alternatively, the multimedia television remote control having a cursor control function has a button assembly, a microprocessor, a pointing device, a transceiving module, a display and a power supply.

The button assembly has a television button set.

The microprocessor serves as a computation control center, stores television control code data and television control signals, and reads and outputs one of the television control code signals in accordance with corresponding television control code data when receiving a button press signal from the television button set.

The pointing device has a joystick and an axial coding unit. The axial coding unit is triggered by the joystick to output a corresponding set of coordinate signals.

The transceiving module is connected to the microprocessor and the pointing device, receives the television control signal, the set of coordinate signals, converts the television control signal and the set of coordinate signals into radio signals, wirelessly transmits the radio signals out, is adapted to receive multimedia signals transmitted from an external network, and converts and transmits the multimedia signals to be processed into multimedia data by the microprocessor to the microprocessor.

The display is connected to the microprocessor for displaying the multimedia data processed and outputted by the microprocessor.

The power supply supplies an operating power to the button assembly, the microprocessor, the pointing device, the transceiving module and the display.

Given the pointing device, the present invention can output a set of coordinate signals after sensing a movement of the trackball or joystick operated by users, and transmit the set of coordinate signals so as to control a television to generate a cursor on the TV screen for operation. Instead of continuously pressing directional arrow buttons upon selecting a choice on a TV screen, users can employ the multimedia TV remote control to directly move the cursor to the choice for inputting corresponding commands.

Other objectives, advantages and novel features of the invention will become more apparent from the following detailed description when taken in conjunction with the accompanying drawings.

### BRIEF DESCRIPTION OF THE DRAWINGS

FIG. 1 is a functional block diagram of a first embodiment of a multimedia TV remote control having a cursor control function in accordance with the present invention;

FIG. 2 is a front view of the multimedia TV remote control in FIG. 1;

FIG. 3 is a functional block diagram of a second embodiment of a multimedia TV remote control having a cursor control function in accordance with the present invention;

FIG. 4 is a functional block diagram of a third embodiment of a multimedia TV remote control having a cursor control function in accordance with the present invention; and

FIG. 5 is a functional block diagram of a fourth embodiment of a multimedia TV remote control having a cursor control function in accordance with the present invention.

### DETAILED DESCRIPTION OF THE INVENTION

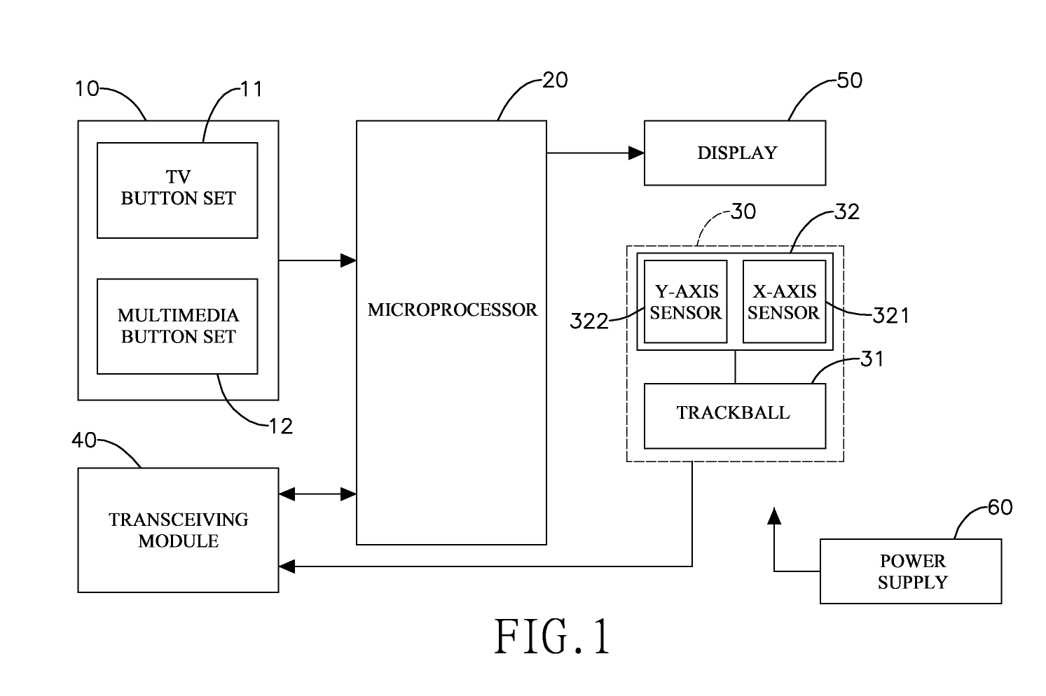

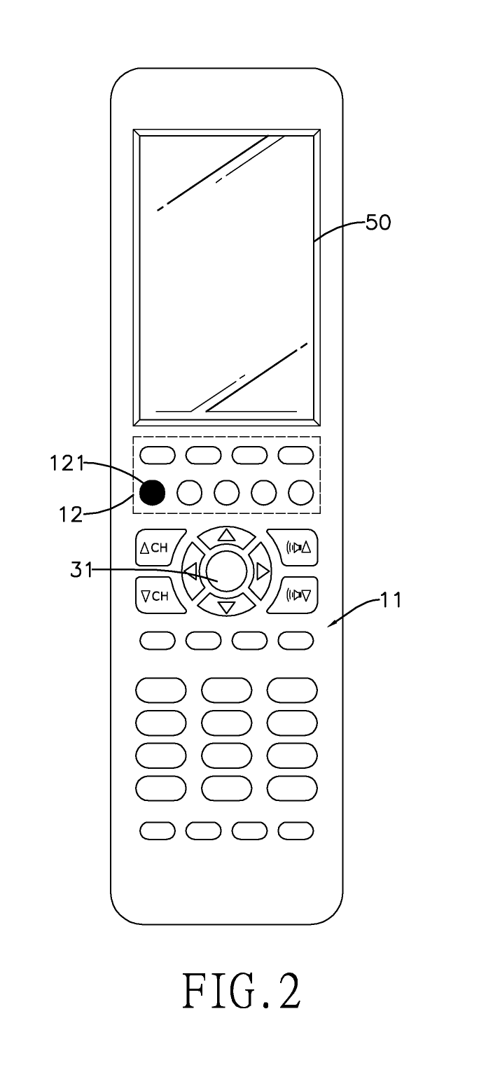

With reference to FIGS. 1 and 2, a first embodiment of a multimedia TV remote control having a cursor control function in accordance with the present invention has a button assembly 10, a microprocessor 20, a pointing device 30, a transceiving module 40, a display 50 and a power supply 60.

The button assembly 10 has a TV button set 11 and a multimedia button set 12. The multimedia button set 12 has an online hot key 121 for users to connect to a network with a single button.

The microprocessor 20 serves as a computation control center, stores TV control code data, multimedia control code data, TV control signals, multimedia control signals and a network connection signal, reads and outputs a TV control signal in accordance with corresponding TV control code data when receiving a button press signal from the TV button set 11, reads and outputs a multimedia control signal in accordance with corresponding multimedia control code data when receiving a button press signal from the multimedia button set 12, and outputs the network connection signal after receiving a button press signal from the online hot key 121.

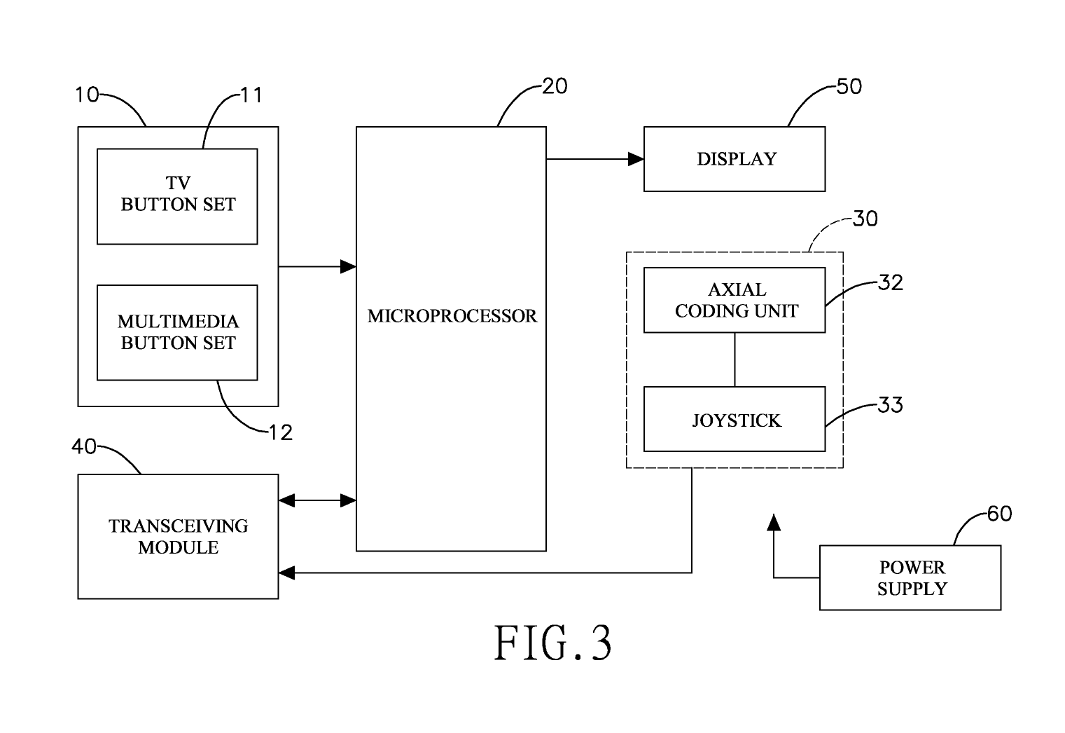

The pointing device 30 has a trackball 31 and an axial coding unit 32. The axial coding unit 32 senses a rolling movement of the trackball 31 and converts the rolling movement into a corresponding set of coordinate signals. In the present embodiment, the axial coding unit has an X-axis sensor 321 and a Y-axis sensor 322 respectively detecting the rolling movements of the trackball 31 along an X axis and a Y axis and converting the rolling movements into an X-axis coordinate signal and a Y-axis coordinate signal. With reference to FIG. 3, a second embodiment of a multimedia TV remote control having a cursor control function in accordance with the present invention is shown. The pointing device 30 alternatively has a joystick 33 and an axial coding unit 32′. The joystick 33 triggers the axial coding unit 32′ to output a corresponding set of coordinate signals.

The transceiving module 40 is connected to the microprocessor 20 and the pointing device 30, receives the TV control signal, the multimedia control signal, the network connection signal, the X-axis coordinate signal and the Y-axis coordinate signal, converts those signals into a radio signal, and wirelessly transmits the radio signal out. The transceiving module 40 also receives multimedia signals transmitted from an external network, converts the multimedia signals and transmits the multimedia signals to be processed into multimedia data by the microprocessor 20 to the microprocessor 20.

The display 50 is connected to the microprocessor 20 for displaying the multimedia data processed and outputted by the microprocessor 20.

The power supply 60 serves to supply an operating power to the button assembly 10, the microprocessor 20, the pointing device 30, the transceiving module 40 and the display.

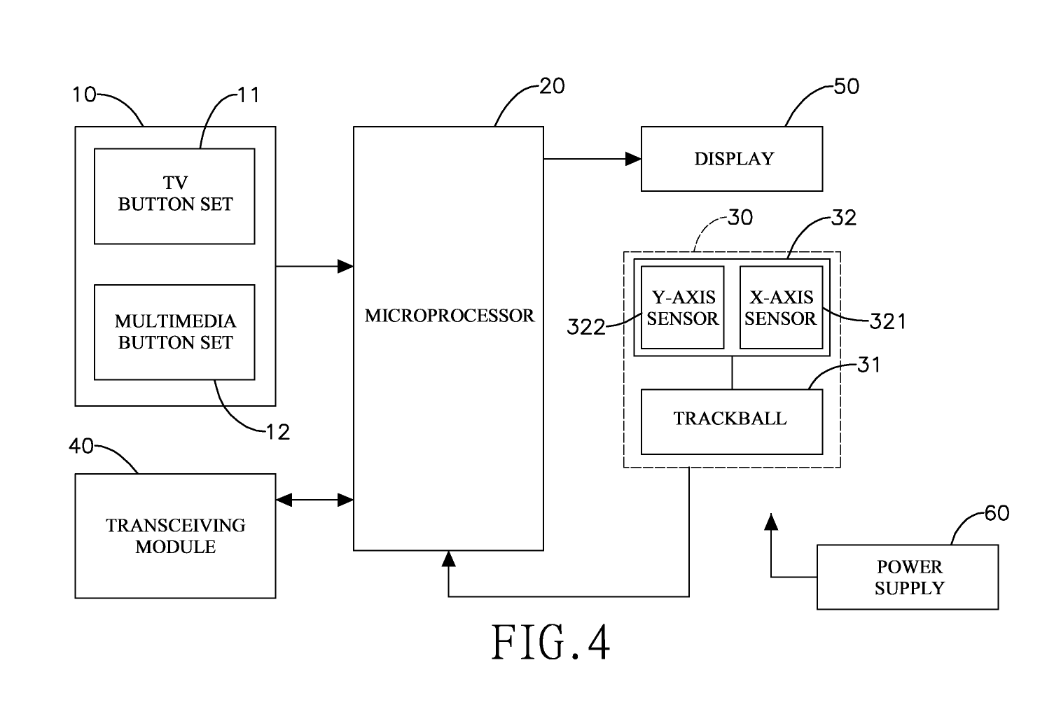

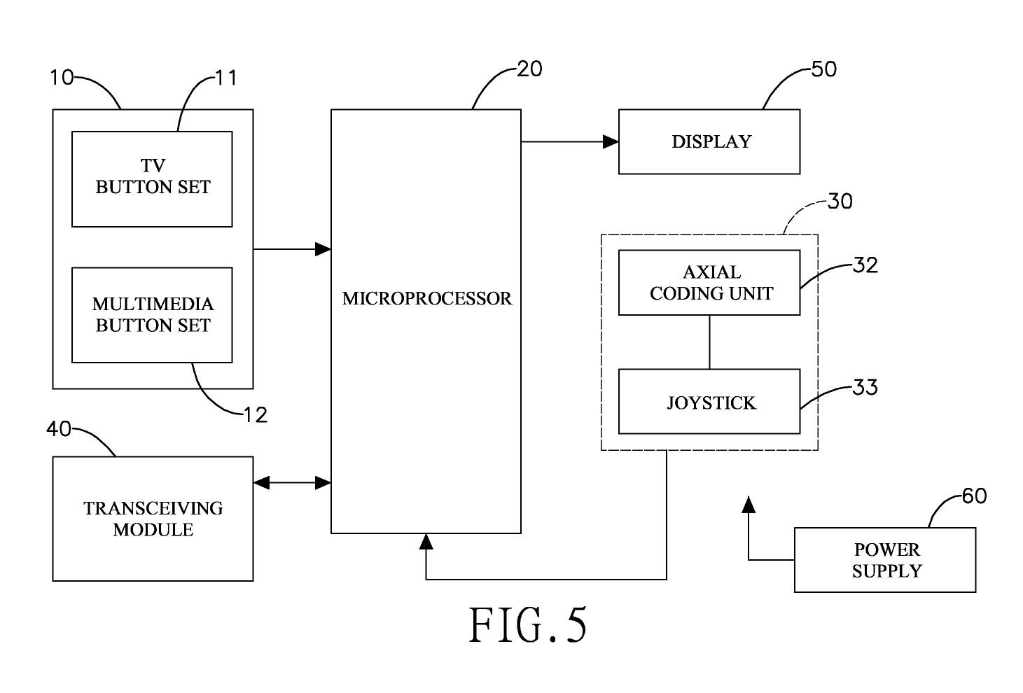

With reference to FIGS. 4 and 5, the pointing device 30 is connected to the microprocessor 20. The X-axis coordinate signals and the Y-axis coordinate signals are outputted from the pointing device 30 to the microprocessor 20, and the microprocessor 20 transmits those coordinate signals out through the transceiving module 40.

When the trackball 31 is rolled, the X-axis sensor 321 and the Y-axis sensor 322 respectively detect an X-axis rolling movement and Y-axis rolling movement, and convert the movements to form an X-axis coordinate signal and a Y-axis coordinate signal. After the X-axis coordinate signal and the Y-axis coordinate signal are transmitted to a TV by the transceiving module 40, a cursor on the TV screen can be remotely controlled to move on the TV screen. The pointing device 30 can also output the X-axis coordinate signal and the Y-axis coordinate signal by moving the joystick 33, and control the cursor to move on the TV screen.

As the multimedia TV remote control having a cursor control function of the present invention has the display 50, after the transceiving module 40 receives a multimedia message transmitted from an external network device, the multimedia message is processed into multimedia information by the microprocessor 10, and the multimedia information is displayed on the display 50. Accordingly, advertisement information and TV program information transmitted from network service providers and TV channel providers through a network can be transmitted to the multimedia TV remote control and displayed on the display 50 without occupying the TV screen. Users can be prevented from being interrupted by abrupt advertisement information transmitted from the network.

Instead of continuously pressing directional arrow buttons for selecting a column choice shown on a TV screen, users can employ the multimedia TV remote control to directly move the cursor to the column choice and then input corresponding commands. A convenient purchase operation rendered by the multimedia TV remote control to stimulate the purchase intention of users also adds a favorable factor in boosting the development of interactive multimedia TV.

Even though numerous characteristics and advantages of the present multimedia TV remote control invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A multimedia television remote control having a cursor control function, comprising:
a button assembly having a television button set;
a microprocessor serving as a computation control center, storing television control code data and television control signals, and reading and outputting one of the television control code signals in accordance with corresponding television control code data when receiving a button press signal from the television button set;
a pointing device having:
a trackball; and
an axial coding unit sensing a rolling movement of the trackball and converting the rolling movement into a corresponding set of coordinate signals;
a transceiving module connected to the microprocessor and the pointing device, receiving the television control signal, the set of coordinate signals, converting the television control signal and the set of coordinate signals into a radio signal, and wirelessly transmitting the radio signal out, adapted to receive multimedia signals transmitted from an external network, and converting and transmitting the multimedia signals to be processed into multimedia data by the microprocessor to the microprocessor;
a display connected to the microprocessor for displaying the multimedia data processed and outputted by the microprocessor; and
a power supply supplying an operating power to the button assembly, the microprocessor, the pointing device, the transceiving module and the display.

2. The multimedia television remote control as claimed in claim 1, wherein the axial coding unit has an X-axis sensor and a Y-axis sensor respectively detecting the rolling movement of the trackball in an X axis and Y axis and converting the rolling movement into an X-axis coordinate signal and a Y-axis coordinate signal.

3. The multimedia television remote control as claimed in claim 1, wherein
the button assembly further has a multimedia button set; and
the microprocessor further stores multimedia control code data and multimedia control signals, reads and outputs a multimedia control code signal in accordance with corresponding multimedia control code data when receiving a button press signal from the multimedia button set, and transmits the multimedia control code signal through the transceiving module.

4. The multimedia television remote control as claimed in claim 2, wherein
the button assembly further has a multimedia button set; and
the microprocessor further stores multimedia control code data and multimedia control signals, reads and outputs a multimedia control code signal in accordance with corresponding multimedia control code data when receiving a button press signal from the multimedia button set, and transmits the multimedia control code signal through the transceiving module.

5. The multimedia television remote control as claimed in claim 3, wherein
the multimedia button set further has an online hot key; and
the microprocessor further stores a network connection signal, and outputs the network connection signal through the transceiving module after receiving a button press signal from the online hot key.

6. The multimedia television remote control as claimed in claim 4, wherein
the multimedia button set further has an online hot key; and
the microprocessor further stores a network connection signal, and outputs the network connection signal through the transceiving module after receiving a button press signal from the online hot key.

7. A multimedia television remote control having a cursor control function, comprising:
a button assembly having a television button set;
a microprocessor serving as a computation control center, storing television control code data and television control signals, and reading and outputting one of the television control code signals in accordance with corresponding television control code data when receiving a button press signal from the television button set;
a pointing device having:
a joystick; and
an axial coding unit triggered by the joystick to output a corresponding set of coordinate signals;
a transceiving module connected to the microprocessor and the pointing device, receiving the television control signal, the set of coordinate signals, converting the television control signal and the set of coordinate signals into a radio signal, and wirelessly transmitting the radio signal out, adapted to receive multimedia signals transmitted from an external network, and converting and transmitting the multimedia signals to be processed into multimedia data by the microprocessor to the microprocessor;
a display connected to the microprocessor for displaying the multimedia data processed and outputted by the microprocessor; and
a power supply supplying an operating power to the button assembly, the microprocessor, the pointing device, the transceiving module and the display.

8. The multimedia television remote control as claimed in claim 7, wherein
the button assembly further has a multimedia button set; and
the microprocessor further stores multimedia control code data and multimedia control signals, reads and outputs a multimedia control code signal in accordance with corresponding multimedia control code data when receiving a button press signal from the multimedia button set, and transmits the multimedia control code signal through the transceiving module.

9. The multimedia television remote control as claimed in claim 8, wherein
the multimedia button set further has an online hot key; and
the microprocessor further stores a network connection signal, and outputs the network connection signal through the transceiving module after receiving a button press signal from the online hot key.

10. A multimedia television remote control having a cursor control function, comprising:
a button assembly having a television button set;
a microprocessor serving as a computation control center, storing television control code data and television control signals, and reading and outputting one of the television control code signals in accordance with corresponding television control code data when receiving a button press signal from the television button set;
a pointing device connected to the microprocessor and having:
a trackball; and
an axial coding unit sensing a rolling movement of the trackball, converting the rolling movement into a corresponding set of coordinate signals, and outputting the set of coordinate signals to the microprocessor for the microprocessor to further transmit the set of coordinate signals out;
a transceiving module connected to the microprocessor and the pointing device, receiving the television control signal, the set of coordinate signals, converting the television control signal and the set of coordinate signals into a radio signal, and wirelessly transmitting the radio signal out, adapted to receive multimedia signals transmitted from an external network, and converting and transmitting the multimedia signals to be processed into multimedia data by the microprocessor to the microprocessor;
a display connected to the microprocessor for displaying the multimedia data processed and outputted by the microprocessor; and
a power supply supplying an operating power to the button assembly, the microprocessor, the pointing device, the transceiving module and the display.

11. The multimedia television remote control as claimed in claim 10, wherein the axial coding unit has an X-axis sensor and a Y-axis sensor respectively detecting the rolling movement of the trackball in an X axis and Y axis and converting the rolling movement into an X-axis coordinate signal and a Y-axis coordinate signal.

12. The multimedia television remote control as claimed in claim 10, wherein
the button assembly further has a multimedia button set; and
the microprocessor further stores multimedia control code data and multimedia control signals, reads and outputs a multimedia control code signal in accordance with corresponding multimedia control code data when receiving a button press signal from the multimedia button set, and transmits the multimedia control code signal through the transceiving module.

13. The multimedia television remote control as claimed in claim 11, wherein
the button assembly further has a multimedia button set; and
the microprocessor further stores multimedia control code data and multimedia control signals, reads and outputs a multimedia control code signal in accordance with corresponding multimedia control code data when receiving a button press signal from the multimedia button set, and transmits the multimedia control code signal through the transceiving module.

14. The multimedia television remote control as claimed in claim 12, wherein
the multimedia button set further has an online hot key; and
the microprocessor further stores a network connection signal, and outputs the network connection signal through the transceiving module after receiving a button press signal from the online hot key.

15. The multimedia television remote control as claimed in claim 13, wherein
the multimedia button set further has an online hot key; and
the microprocessor further stores a network connection signal, and outputs the network connection signal through the transceiving module after receiving a button press signal from the online hot key.

16. A multimedia television remote control having a cursor control function, comprising:
a button assembly having a television button set;
a microprocessor serving as a computation control center, storing television control code data and television control signals, and reading and outputting one of the television control code signals in accordance with corresponding television control code data when receiving a button press signal from the television button set;
a pointing device connected to the microprocessor and having:
a joystick; and
an axial coding unit triggered by the joystick to output a corresponding set of coordinate signals, and outputting the set of coordinate signals to the microprocessor for the microprocessor to further transmit the set of coordinate signals out;
a transceiving module connected to the microprocessor and the pointing device, receiving the television control signal, the set of coordinate signals, converting the television control signal and the set of coordinate signals into a radio signal, and wirelessly transmitting the radio signal out, adapted to receive multimedia signals transmitted from an external network, and converting and transmitting the multimedia signals to be processed into multimedia data by the microprocessor to the microprocessor;
a display connected to the microprocessor for displaying the multimedia data processed and outputted by the microprocessor; and
a power supply supplying an operating power to the button assembly, the microprocessor, the pointing device, the transceiving module and the display.

17. The multimedia television remote control as claimed in claim 16, wherein
the button assembly further has a multimedia button set; and
the microprocessor further stores multimedia control code data and multimedia control signals, reads and outputs a multimedia control code signal in accordance with corresponding multimedia control code data when receiving a button press signal from the multimedia button set, and transmits the multimedia control code signal through the transceiving module.

18. The multimedia television remote control as claimed in claim 17, wherein
the multimedia button set further has an online hot key; and
the microprocessor further stores a network connection signal, and outputs the network connection signal through the transceiving module after receiving a button press signal from the online hot key.
